(19) United States
(12) Patent Application Publication
(10) Pub. No.: US 2026/0341094 A1
(43) Pub. Date: Oct. 29, 2026

(54) Cassette Connecting Device for Automatic Teller Machine

(71) Applicant: HYOSUNG TNS INC., Seoul (KR)

(72) Inventors: Sung Ho PARK, Seoul (KR); Hyun Soo JANG, Seoul (KR); Seungsik JEONG, Seoul (KR)

(21) Appl. No.: 19/117,794

(22) PCT Filed: Sep. 15, 2023
(86) PCT No.: PCT/KR2023/013878

§ 371 Date: Apr. 2, 2025

(30) Foreign Application Priority Data
Oct. 5, 2022 (KR) 10-2022-0126723

(51) Int. Cl. G07D 11/40; G07D 11/125; G07D 11/245

(52) U.S. Cl. CPC G07D 11/40; G07D 11/125; G07D 11/245; G07D 2211/00

(57) ABSTRACT

A cassette connecting device for an automated teller machine comprises: a body installed in the replenishment access section and providing a receiving space into which the replenishment cassette is to be inserted; a handle frame rotatably connected to the body to open and close the receiving space; a connection connector installed in the body and electrically connectable with a cassette connector of the replenishment cassette when the replenishment cassette is inserted into the receiving space; and a power transmission unit connecting the handle frame and the connection connector so that the handle frame and the connection connector are interlocked, wherein the power transmission unit rotates the connection connector to a point corresponding to the cassette connector when the handle frame is rotated to open the receiving space.

### TECHNICAL FIELD

The present disclosure relates to a cassette connecting device for an automated teller machine.

### BACKGROUND ART

In general, an automated teller machine is a device that allows users to perform deposits and withdrawals of cash or checks, account transfers, and account inquiries without time constraints using a cash card or passbook issued by a financial institution, and it is widely used in the financial industry because it enables quick processing of users' financial transactions.

The automated teller machine may include an upper body provided with a deposit and withdrawal unit, a temporary holding unit, an identification unit, and a conveyance path, and a lower body provided with a plurality of cassettes. In the automated teller machine, the use of a replenishment cassette capable of replenishing and recovering mediums is increasing. The replenishment cassette may be mounted to the lower body through a cassette connecting device, and a cassette connector of the replenishment cassette may be physically and electrically connected to a connection connector of the cassette connecting device when the replenishment cassette is mounted to the cassette connecting device.

However, since the cassette connector of the replenishment cassette is arranged on the bottom of the replenishment cassette to extend in a transverse direction of the replenishment cassette (left-right direction of the financial automation machine) and the connection connector of the cassette connecting device to be connected to the cassette connector is also arranged to extend on the cassette connecting device, there is a problem in that the space in which mediums are stacked inside the replenishment cassette is restricted by the cassette connector.

Meanwhile, if the cassette connector of the replenishment cassette is arranged on the bottom of the replenishment cassette in a longitudinal direction, the connection connector of the cassette connecting device needs to be arranged in the longitudinal direction to correspond to the cassette connector for the connection with the cassette connector. In this case, since the connection connector protrudes in a front-rear direction of the automated teller machine in the overall layout of the lower body, unnecessary space may be required in the lower body for the protruding shape of the connection connector.

Accordingly, there is a need for a technology that allows for changing the rotational position of the connection connector so that the medium stack space of the replenishment cassette can be enlarged, and that allows for slimming the front-to-rear length of the lower body on which the cassette connecting device is installed through the rotational position change of the connection connector.

### DETAILED DESCRIPTION OF INVENTION

### Technical Problems

Embodiments of the present disclosure have been conceived in view of the above background to provide a cassette connecting device for an automated teller machine, in which the position of a connection connector can be changed so that a medium stack space in a replenishment cassette can be enlarged, and the front-to-rear length of a lower body on which the cassette connecting device is installed can be slimmed down by changing the rotational position of the connection connector.

### Technical Solution

In accordance with one embodiment of the present disclosure, a cassette connecting device for an automated teller machine, which is to be installed in a replenishment access section and to which a replenishment cassette is to be connected, the cassette connecting device comprises: a body installed in the replenishment access section and providing a receiving space into which the replenishment cassette is to be inserted; a handle frame rotatably connected to the body to open and close the receiving space; a connection connector installed in the body and electrically connectable with a cassette connector of the replenishment cassette when the replenishment cassette is inserted into the receiving space; and a power transmission unit connecting the handle frame and the connection connector so that the handle frame and the connection connector are interlocked, wherein the power transmission unit rotates the connection connector to a point corresponding to the cassette connector when the handle frame is rotated to open the receiving space.

Further, the power transmission unit may rotate the connection connector in one direction so that the connection connector is exposed from the body when the handle frame is rotated in a direction to open the receiving space, and rotate the connection connector in the other direction so that the connection connector is not exposed from the body when the handle frame is rotated in a direction to close the receiving space.

Further, the power transmission unit may include: a rotating bracket rotatably installed on the body, to which the connection connector is mounted; a first gear rotatably installed on the body, which rotates in one direction when pushed by the rotation of the handle frame; a second gear rotatably installed on the body to mesh with at least a portion of the first gear, which rotates in the other direction when the first gear is rotated in the one direction; and a third gear rotatably installed on the body to mesh with at least a portion of the second gear, which rotates the rotating bracket in the one direction when the second gear is rotated in the other direction.

Further, the power transmission unit may further include a return spring elastically connected between a fixed bracket of the body and the rotating bracket to return the third gear to an initial position thereof when the push of the handle frame against the first gear is released.

Further, the body may include: a support frame; a rotation shaft provided at a lower portion of the support frame, to which the handle frame is rotatably connected; a moving shaft provided at an upper portion of the support frame to be movable in a front-rear direction of the support frame; and a support plate having a lower portion rotatably connected to the rotation shaft and an upper portion rotatably connected to the moving shaft.

Further, the body further may include: a guide frame that hinge-connects between both sides of the support plate and both sides of the handle frame; and a guide pin that is coupled to both sides of the support plate, and wherein the guide frame may include: a guide rod portion having one end portion hinge-connected to an upper portion of the handle frame; and a guide slit portion formed to extend at the other end portion of the guide rod portion so that the guide pin is guided in a length direction of the guide rod portion.

Further, the support frame may include: a support frame portion; and a support hole portion formed to extend in the front-rear direction in a sidewall of the support frame portion to provide a movement path of the moving shaft.

Further, a cassette connecting device for an automated teller machine, which is to be installed in a replenishment access section and to which a replenishment cassette is to be connected, the cassette connecting device may comprise: a body installed in the replenishment access section and providing a receiving space into which the replenishment cassette is to be inserted; and a connection connector movably arranged on the body to be electrically connected to a cassette connector of the replenishment cassette, wherein the connection connector is arranged at a preset first point of the body before the replenishment cassette is inserted into the receiving space, and is arranged at a second point corresponding to the cassette connector when the replenishment cassette is inserted into the receiving space.

Further, the cassette connecting device may further comprise: a handle frame rotatably connected to the body to open and close the receiving space; and a power transmission unit configured to move the connection connector in the body in conjunction with the rotation of the handle frame.

### Effect of Invention

According to embodiments of the present disclosure, when the replenishment cassette is mounted to the automated teller machine, the connection connector can be rotated to be positioned at a side end portion of the cassette connecting device, so that the cassette connector connected to the connection connector can be designed to be positioned on a side end portion of the replenishment cassette, thereby expanding the medium stack space in the replenishment cassette.

Further, according to embodiments of the present disclosure, the front-to-rear length of the lower body on which the cassette connecting device is installed can be slimmed down by changing the rotational position of the connection connector.

In addition, according to embodiments of the present disclosure, the frequency of replenishing mediums in the automated teller machine can be significantly reduced as the medium stack space in the replenishing cassette is enlarged.

### BRIEF DESCRIPTION OF THE DRAWINGS

FIG. 1 is a state diagram illustrating a state of a cassette connecting device when a medium is replenished through a replenishment cassette in an automated teller machine according to one embodiment of the present disclosure.

FIG. 2 is a state diagram illustrating the cassette connecting device according to one embodiment of the present disclosure in a closed state before the replenishment cassette is mounted to the automated teller machine.

FIG. 3 is a state diagram illustrating the cassette connecting device according to one embodiment of the present disclosure in an open state before the replenishment cassette is mounted to the automated teller machine.

FIG. 4 is a state diagram illustrating the cassette connecting device according to one embodiment of the present disclosure in the open state when the replenishment cassette is mounted to the automated teller machine.

FIG. 5 is a perspective view of the cassette connecting device according to one embodiment of the present disclosure, viewed from one direction, before the replenishment cassette is mounted to the automated teller machine.

FIG. 6 is a state diagram illustrating the cassette connecting device according to one embodiment of the present disclosure in the open state.

FIG. 7 is an enlarged view of a power transmission unit, which is an enlarged view of part “A” in FIG. 6.

FIG. 8 is a bottom view of the power transmission unit, which is seen from line B-B′ of FIG. 7.

FIG. 9 is a perspective view of the cassette connecting device according to one embodiment of the present disclosure shown in FIG. 6 which is seen from another direction.

FIG. 10 is an enlarged view of the power transmission unit, which is an enlarged view of part “C” in FIG. 9.

### BEST MODE FOR CARRYING OUT THE INVENTION

Hereinafter, the configuration and operation according to the embodiment of the present invention will be described in detail with reference to the attached drawings. The following description is one of the aspects of the present invention that can be claimed as a patent, and the following description may form a part of the detailed description of the present invention.

However, in describing the present invention, specific descriptions of known configurations or functions may be omitted in order to clarify the present invention.

The present invention may have various modifications and may include various embodiments, and specific embodiments are illustrated in the drawings and described in the detailed description. However, this is not intended to limit the present invention to specific embodiments, but should be understood to include all modifications, equivalents, or substitutes included in the spirit and technical scope of the present invention.

Terms that include ordinal numbers such as first, second, etc. may be used to describe various components, but the components are not limited by such terms. These terms are used only for the purpose of distinguishing one component from another.

The terms used in this application are used only to describe specific embodiments, and are not intended to limit the present invention. Singular expressions include plural expressions unless the context clearly indicates otherwise.

Hereinafter, a cassette connecting device of an automated teller machine according to one embodiment of the present disclosure will be described with reference to the accompanying drawings.

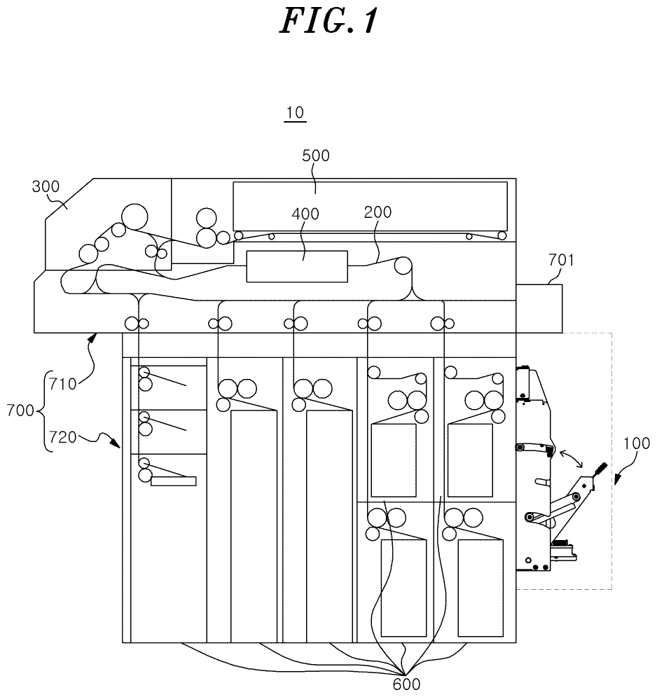

Referring to FIG. 1, an automated teller machine 10 according to one embodiment of the present disclosure may include a cassette connecting device 100, a conveyance path 200, a deposit and withdrawal unit 300, an identification unit 400, a temporary holding unit 500, a cassette 600, and a main body 700.

The cassette connecting device 100 may be installed at a lower side of a replenishment access section 701 of the main body 700. The cassette connecting device 100 may be opened and closed by a cover. When the cover is open, a replenishment cassette for replenishing and recovering mediums can be mounted to the cassette connecting device 100. A connection connector to be physically and electrically connected to a cassette connector of the cassette connecting device 100 may be installed to be rotatable when the replenishment cassette is mounted to the cassette connecting device 100. A detailed description of the cassette connecting device 100 will be described later.

The conveyance path 200 may provide a medium transfer route in the internal space of the main body 700. The conveyance path 200 may provide a movement path for a medium deposited and withdrawn through the deposit and withdrawal unit 300. For example, the conveyance path 200 can guide a medium deposited through the deposit and withdrawal unit 300 to the identification unit 400, the temporary holding unit 500, and the cassette 600, or guide a medium discharged from the cassette 600 to the identification unit 400 and the deposit and withdrawal unit 300.

The deposit and withdrawal unit 300 may provide a deposit and withdrawal space for inserting or receiving mediums. The deposit and withdrawal unit 300 may include belts, rollers, motors, etc. for transferring mediums. Since the configurations of the belts, rollers, motors, etc. are general matters in medium transfer, a detailed description thereof will be omitted.

The identification unit 400 may be installed on the conveyance path 200. The identification unit 400 can identify the type and abnormality of a medium passing through the conveyance path 200. When counting deposited mediums, normal mediums identified as having no abnormalities by the identification unit 400 may be temporarily stored in the temporary holding unit 500, and suspicious mediums identified as having abnormalities by the identification unit 400 may be returned to the customer through the deposit and withdrawal unit 300.

The temporary holding unit 500 may provide a storage space for temporarily storing mediums identified by the identification unit 400. The temporary holding unit 500 may receive mediums identified by the identification unit 400 through the conveyance path 200.

The cassette 600 may provide a stack space where mediums can be stored upon deposit. The cassette 600 may discharge mediums stored in the stack space upon withdrawal. The cassette 600 may include a plurality of cassettes having different sizes depending on denomination type. For example, the cassette 600 may include a reject cassette, a recycle cassette, a deposit cassette, a replenishment cassette 800, etc.

The main body 700 may provide a storage space for storing mediums. The main body 700 may comprise a frame/housing that provides the overall appearance of the automated teller machine 10. The main body 700 may include an upper main body 710 accommodating the deposit and withdrawal unit 300 and the identification unit 400, and a lower main body 720 accommodating the plurality of cassettes 600.

The configuration of the automated teller machine 10 described above is provided as an example to help understand the present embodiment. Therefore, other components may be added as needed, and the configuration and structure may be modified and changed according to the needs of an implementer.

Hereinafter, the cassette connecting device of the automated teller machine according to one embodiment of the present disclosure will be specifically described.

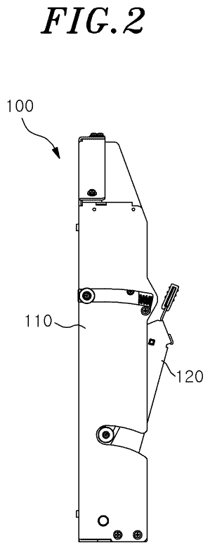

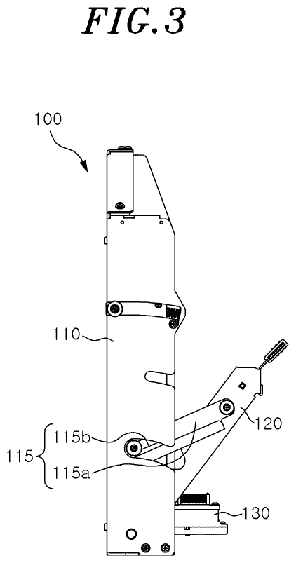

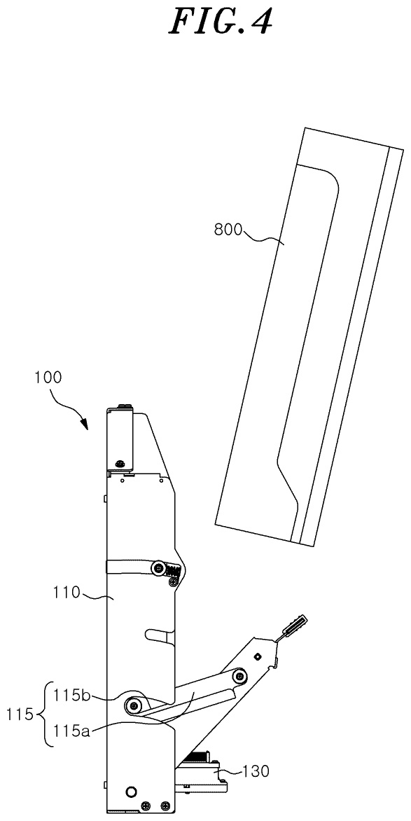

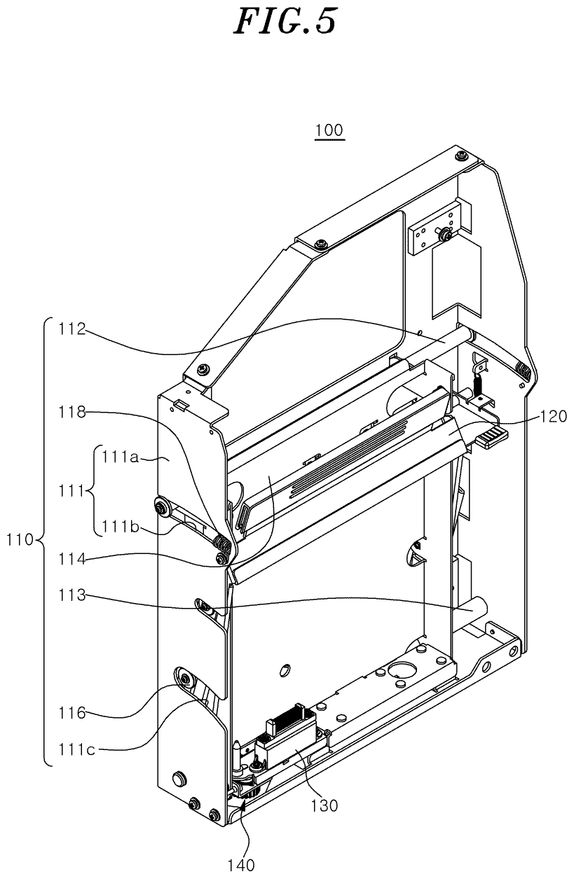

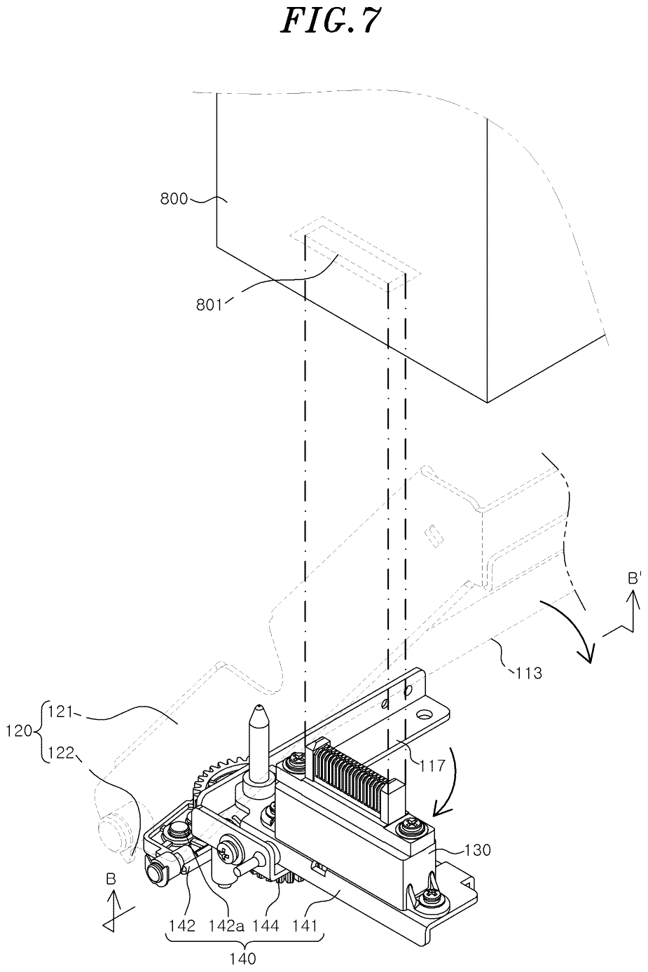

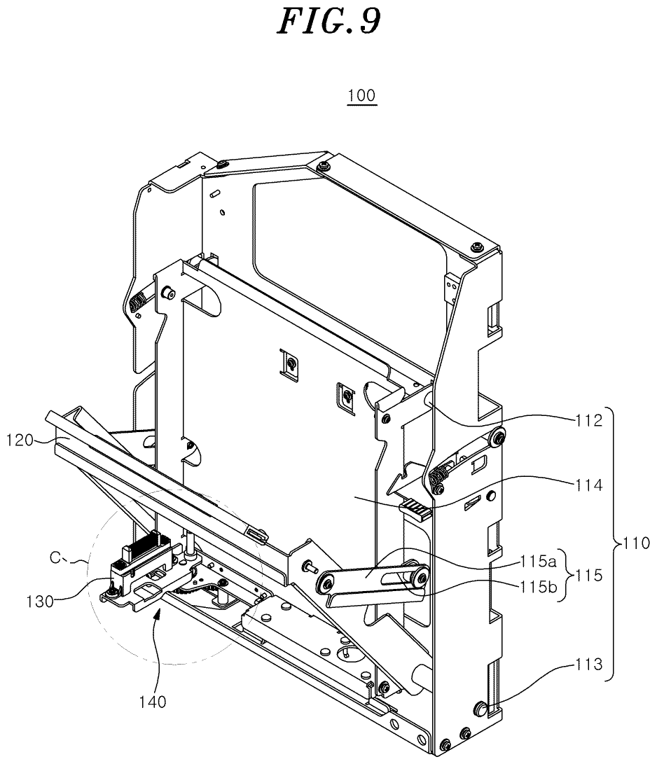

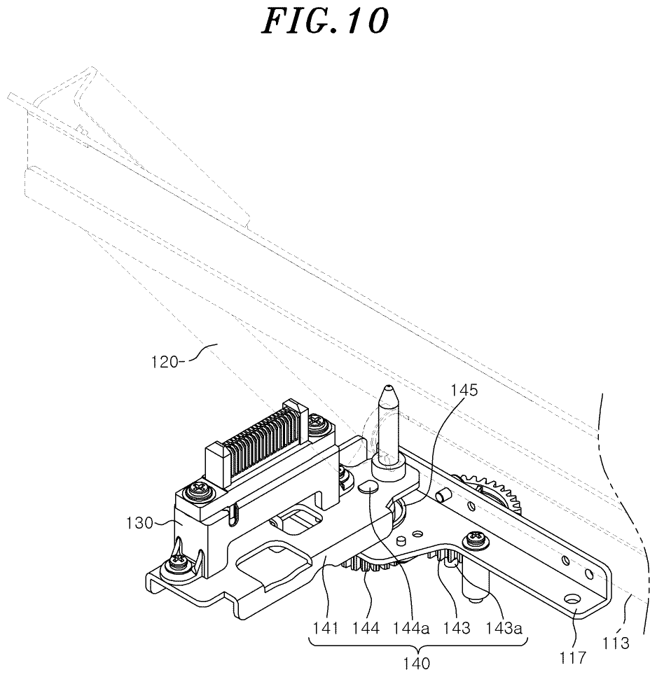

Referring to FIGS. 2 to 10, the cassette connecting device 100 according to one embodiment of the present disclosure may include a body 110, a handle frame 120, a connection connector 130, and a power transmission unit 140.

The body 110 may include a frame installed in a replenishment access section. The body 110 may provide a receiving space into which the replenishment cassette 800 can be inserted. A cassette connector 801, which can be electrically connected to the connection connector 130, may be provided on a bottom surface of the replenishment cassette 800. When the cassette connector 801 is arranged on the bottom surface of the replenishment cassette 800 to extend in a longitudinal direction of the replenishment cassette 800 (a front-rear direction of the automated teller machine), the space in which mediums are stacked within the replenishment cassette 800 is not restricted by the cassette connector 801 compared to a case where the cassette connector 801 is arranged to extend in a transverse direction of the replenishment cassette 800 (a left-right direction of the automated teller machine), and thus an enlarged stack space within the replenishment cassette 800 can be expected.

A door (not shown) for opening and closing the receiving space may be rotatably mounted on the body 110. The body 110 may include a support frame 111, a rotation shaft 113, a moving shaft 112, a support plate 114, a guide frame 115, a guide pin 116, a fixed bracket 117, and a buffer spring 118.

The support frame 111 may include a support frame portion 111a that provides the overall appearance of the support frame 111, a support hole portion 111b that provides a movement path of the moving shaft 112 in an upper portion of the support frame portion 111a, and a support slot portion 111c that provides a rotation path of the guide pin 116 in a lower portion of the support frame portion 111a.

The support hole portion 111b may be a long hole shape that extends in the front-rear direction at the upper portions of both sides of the support frame portion 111a. Both ends of the moving shaft 112 may be supported by the support hole portion 111b. The buffer spring 118 may be installed at one end of the support hole portion 111b to buffer the impact caused by the collision of the moving shaft 112.

The support slot portion 111c may be a slot formed to extend in the front-rear direction in the lower portion of one side of the support frame portion 111a. The guide pin 116 may be positioned in the support slot portion 111c. When the support plate 114 rotates about the rotation shaft 113, the support hole portion 111b can guide the rotation path of the support plate 114 through the moving shaft 112, and the support slot portion 111c can guide the rotation path of the support plate 114 through the guide pin 116.

The moving shaft 112 may be arranged parallel to the rotation shaft 113 at an upper portion of the support frame 111. Both ends of the moving shaft 112 may be assembled to the upper portion of the support frame 111. Both ends of the moving shaft 112 may be positioned in the support hole portion 111b of the support frame 111. When the support plate 114 rotates about the rotation shaft 113, the moving shaft 112 can move in the front-rear direction of the support frame 111 along the support hole portion 111b of the support frame 111.

The rotation shaft 113 may be a rotation axis for allowing the handle frame 120 to rotate relative to the support frame 111. The rotation shaft 113 may be provided at a lower portion of the support frame 111. A lower portion of the handle frame 120 may be connected to both ends of the rotation shaft 113. When the handle frame 120 is pulled or pushed by a user, the rotation shaft 113 can be rotated in the lower portion of the support frame 111 in conjunction with the rotation of the handle frame 120.

The support plate 114 may be rotatably connected to the lower portion of the support frame 111 through the rotation shaft 113. The upper portion of the support plate 114 may be rotatably assembled to the moving shaft 112. The support plate 114 can provide a receiving space formed between it and the handle frame 120 that can accommodate mediums. The support plate 114 may be connected to the handle frame 120 through the guide frame 115 to allow interlocked movement. When the handle frame 120 is rotated by a user's pull or push action, the support frame 111 can be rotated in conjunction with the rotation of the handle frame 120.

The guide frame 115 may be hinge-connected between both sides of the support plate 114 and both sides of the handle frame 120 to control the maximum rotation angle of the handle frame 120. The guide frame 115 may include a guide rod portion 115a and a guide slit portion (115b). One end portion of the guide rod portion 115a may be hinge-connected to an upper portion of the handle frame 120. The guide slit portion 115b may be formed at the other end portion of the guide rod portion 115a. The guide slit portion 115b may be an elongated hole formed to extend in the other end portion of the guide rod portion 115a. The guide pin 116 assembled to both sides of the support plate 114 may be positioned in the guide slit portion 115b. When the support plate 114 rotates about the rotation shaft 113, the guide pin 116 can move in the guide slit portion 115b along a length direction of the guide rod portion 115a.

The guide pin 116 may be coupled to the lower portions of both sides of the support plate 114. The guide pin 116 may be positioned to overlap with the guide slit portion 115b of the guide frame 115 and the support slot portion 111c of the support frame 111. When the support plate 114 is rotated about the rotation shaft 113, the guide pin 116 can move in the front-rear direction of the support frame 111 along the support hole portion 111b of the support frame 111, and when the handle frame 120 is rotated about the rotation shaft 113, the guide pin 116 can move in the length direction of the guide frame 115 along the guide slit portion 115b of the guide frame 115.

The handle frame 120 may be a grip that can be held by a user. The handle frame 120 may be rotatably connected to the body 110 to open and close the receiving space of the body 110. The handle frame 120 may be rotatably connected to the body 110 through the rotation shaft 113. The lower portion of the handle frame 120 may be rotatably connected to the lower portion of the body 110 through the rotation shaft 113, and the upper portion of the handle frame 120 may be rotatably connected to the support plate 114 through the guide frame 115.

The handle frame 120 can open or close the receiving space for the replenishment cassette 800 in the body 110 by a user's pull or push action. For example, when a user pulls the handle frame 120, the handle frame 120 can move away from the support plate 114 to open the receiving space, and when the user pushes the handle frame 120, the handle frame 120 can move closer to the support plate 114 to close the receiving space.

The handle frame 120 may include a handle frame portion 121 and a handle locking portion 122. The handle locking portion 122 may be provided at an end of the handle frame portion 121 in the form of a locking protrusion. When a user pulls the handle frame 120 in a direction away from the receiving space of the body 110, the push of the handle locking portion 122 of the handle frame 120 against one end of a first gear 142 can be released, and at this time, the rotational force of the handle frame 120 is transmitted to the connection connector 130, so that the connection connector 130 can be deployed while rotating outward from the internal space of the body 110. Further, when the user pushes the handle frame 120 toward the receiving space of the body 110, the handle locking portion 122 of the handle frame 120 pushes one end of the first gear 142, so that the rotational power of the handle frame 120 is transmitted to the connection connector 130, and the connection connector 130 can be moved into the internal space of the body 110.

The connection connector 130 may be rotatably installed at the lower portion of the body 110. The connection connector 130 may be positioned at a first point of the body, for example, in the internal space of the body 110 parallel to the transverse direction of the body 110, before the replenishment cassette 800 is inserted into the receiving space, and when the replenishment cassette is inserted into the receiving space, the connection connector 130 may be positioned at a second point corresponding to the cassette connector, for example, in a direction perpendicular to the transverse direction of the body 110.

The connection connector 130 may be moved in conjunction with the rotation of the handle frame 120 through the power transmission unit 140. In normal use, the connection connector 130 may be positioned in the inner space of the body 110. In other words, the connection connector 130 may be arranged parallel to the transverse direction of the body to overlap with the inner space of the body 110. In this case, the length direction of the connection connector 130 may be matched with the transverse direction of the body.

Further, when the handle frame 120 is pulled, the connection connector 130 may be rotated outwardly from the inner space of the body 110 to be deployed. In other words, the connection connector 130 may be rotated 90 degrees in a direction perpendicular to the transverse direction of the body 110, for example, in the longitudinal direction. In this case, one end of the connection connector 130 may be spun at an end of the body 110, and the other end of the connection connector 130 may be rotated in a direction away from the inner space of the body.

When the handle frame 120 is pulled and the replenishment cassette 800 is inserted into the receiving space, the connection connector 130 is positioned at a point corresponding to the cassette connector of the replenishment cassette 800, so that the connection connector 130 can be electrically connected to the cassette connector of the replenishment cassette 800. Meanwhile, when the handle frame 120 is pushed, the connection connector 130 can be rotated inward and moved to its original position in the internal space of the body 110.

The cassette connector 801 of the replenishment cassette 800 used in the present embodiment may be positioned to match with the connection connector 130 that has been rotated 90 degrees in the direction perpendicular to the transverse direction of the body 110 when the handle frame 120 is pulled, that is, may be in a form that is transversely extended in one end portion of the replenishment cassette 800 to match with the connection connector 130. Since the cassette connector 801 is positioned offset to one end of the replenishment cassette 800, other spaces where the cassette connector 801 is not positioned can be utilized as a medium stack space in the replenishment cassette 800. For example, when the cassette connector 801 is arranged to extend on the bottom surface of the replenishment cassette 800 in the longitudinal direction of the replenishment cassette 800 (the front-rear direction of the automated teller machine), the medium stack space of the replenishment cassette 800 can be enlarged compared to the case of the replenishment cassette 800 in which the cassette connector 801 is arranged to extend long in the transverse direction.

The power transmission unit 140 may connect the handle frame 120 and the connection connector 130 so that the handle frame 120 and the connection connector 130 are interlocked. When the receiving space in the body 110 is opened by the rotation of the handle frame 120, the power transmission unit 140 can rotate the connection connector 130 to a point corresponding to the cassette connector 801. The power transmission unit 140 may include a rotating bracket 141, a first gear 142, a second gear 143, a third gear 144, and a return spring 145.

The rotating bracket 141 may be rotatably installed on the fixed bracket 117 of the body 110. The connection connector 130 may be mounted on the rotating bracket 141. The first gear 142 may be rotatably installed on the fixed bracket 117 of the body 110 through a first gear shaft 142a.

The second gear 143 may be rotatably installed on the fixed bracket 117 through a second gear shaft 143a. The second gear 143 may be arranged to mesh with at least some of the teeth of the first gear 142.

The third gear 144 may be rotatably installed on the fixed bracket 117 through a third gear shaft 144a while being fixedly installed on the rotating bracket 141. The third gear 144 may be arranged to mesh with at least some of the teeth of the second gear 143.

The return spring 145 may elastically connect the fixed bracket 117 and the rotating bracket 141. The return spring 145 can provide an elastic restoring force so that the connection connector 130 is positioned at the second point, that is, so that the connection connector 130 is arranged in a direction perpendicular to the transverse direction of the body 110. For example, when the handle frame 120 is pulled, that is, when the push of the handle frame 120 against the first gear 142 is released, the connection connector 130 can be moved by the elastic restoring force of the return spring 145 to the second point where the connection connector 130 is arranged in the direction perpendicular to the transverse direction of the body 110.

Hereinafter, the operational effects of the cassette connecting device according to one embodiment of the present disclosure will be described.

First, when a user pulls the handle frame 120 while the door of the cassette connecting device is open, the handle frame 120 rotates about the rotation shaft 113 as the rotation axis, thereby opening the receiving space and maintaining a state in which the replenishment cassette 800 can be inserted. In this case, as the connection connector 130 is interlinked with the handle frame 120 through the power transmission unit 140, the connection connector 130 can be rotated 90 degrees outward from the internal space of the body 110 to be deployed.

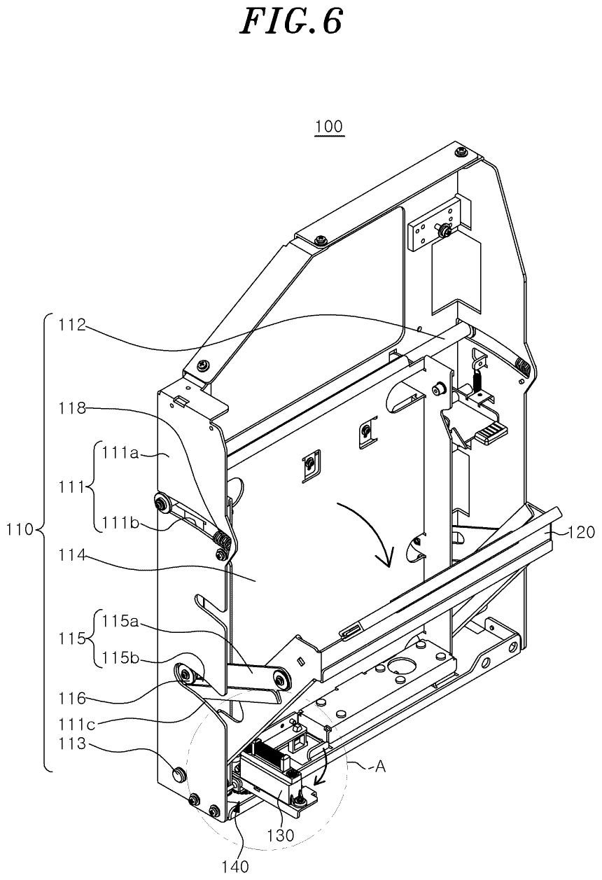

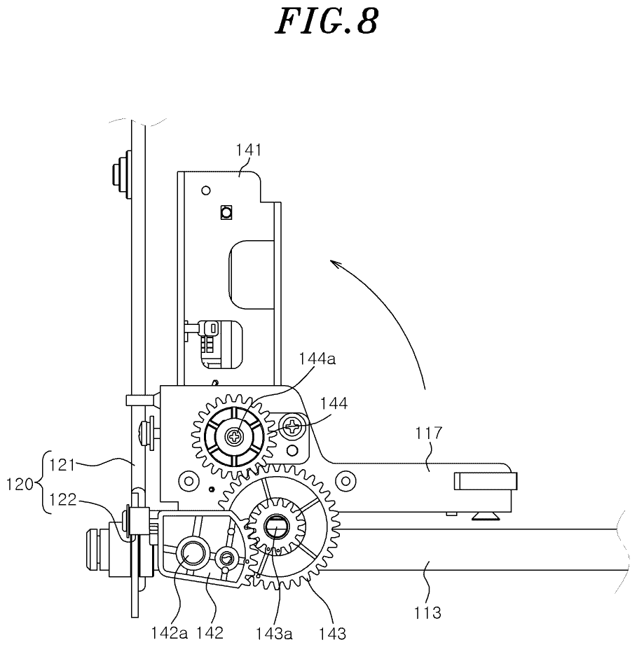

For example, referring to FIGS. 6 to 8, when the handle frame 120 is pulled by the user, the push of the handle frame 120 against the first gear 142 is released, so that the connection connector 130 can be moved by the elastic restoring force of the return spring 145 to the second point where the connection connector 130 is arranged in the direction perpendicular to the transverse direction of the body 110. When the elastic restoring force of the return spring 145 is applied to the rotating bracket 141, the rotating bracket 141 can be rotated in the counterclockwise direction in FIG. 8. In this case, the third gear 144, the second gear 143, and the first gear 142 can be rotated sequentially by the rotation of the rotating bracket 141. The rotating bracket 141 can rotate the connection connector 130 outwardly in the internal space of the body 110 in conjunction with the rotation of the third gear 144. Through the rotation of the rotating bracket 141, the connection connector 130 is positioned at a point corresponding to the cassette connector 801 of the replenishment cassette 800.

Thereafter, when the user inserts the replenishment cassette 800 into the receiving space, the cassette connector 801 of the replenishment cassette 800 can be physically and electrically connected to the connection connector 130. In this state, the mediums in the replenishment cassette 800 can be supplied to the automated teller machine.

Meanwhile, when the handle frame 120 is pushed with a force greater than the elastic restoring force of the return spring 145, the handle frame 120 rotates about the rotation shaft 113, and the handle locking portion 122 of the handle frame 120 can push one end of the first gear 142. When one end of the first gear 142 is pushed by the rotation of the handle frame 120, the second gear 143 and the third gear 144 can be rotated sequentially by the rotation of the first gear 142. At this time, the rotating bracket 141 moves in conjunction with the rotation of the third gear 144 to rotate the connection connector 130 to the first point in the internal space of the body 110.

As described above, according to the present disclosure, when the replenishment cassette 800 is mounted in the automated teller machine, the connection connector 130 can be rotated to be positioned at the side end portion of the cassette connecting device 100, so that the cassette connector 801 to be connected to the connection connector 130 can be designed to be positioned on the side end portion of the replenishment cassette 800, which allows the medium stack space in the replenishment cassette 800 to be enlarged, and as the medium stack space in the replenishment cassette 800 is enlarged, the frequency of replenishing mediums in the automated teller machine can be significantly reduced.

Although the embodiments of the present disclosure have been described as specific embodiments, this is merely an example, and the present disclosure should be construed as having the broadest scope according to the technical idea disclosed herein without being limited thereto. Those skilled in the art may implement a pattern of a shape not indicated herein by combining/substituting the disclosed embodiments, but this also does not deviate from the scope of the present disclosure. In addition, those skilled in the art may easily change or modify the disclosed embodiments based on the present specification, and it is clear that such changes or modifications also fall within the scope of the present disclosure.

What is claimed is:

1. A cassette connecting device for an automated teller machine, which is to be installed in a replenishment access section and to which a replenishment cassette is to be connected, the cassette connecting device comprising:
a body installed in the replenishment access section and providing a receiving space into which the replenishment cassette is to be inserted;
a handle frame rotatably connected to the body to open and close the receiving space;
a connection connector installed in the body and electrically connectable with a cassette connector of the replenishment cassette when the replenishment cassette is inserted into the receiving space; and
a power transmission unit connecting the handle frame and the connection connector so that the handle frame and the connection connector are interlocked,
wherein the power transmission unit rotates the connection connector to a point corresponding to the cassette connector when the handle frame is rotated to open the receiving space.

2. The cassette connecting device of claim 1, wherein the power transmission unit rotates the connection connector in one direction so that the connection connector is exposed from the body when the handle frame is rotated in a direction to open the receiving space, and rotates the connection connector in the other direction so that the connection connector is not exposed from the body when the handle frame is rotated in a direction to close the receiving space.

3. The cassette connecting device of claim 2, wherein the power transmission unit includes:
a rotating bracket rotatably installed on the body, to which the connection connector is mounted;
a first gear rotatably installed on the body, which rotates in one direction when pushed by the rotation of the handle frame;
a second gear rotatably installed on the body to mesh with at least a portion of the first gear, which rotates in the other direction when the first gear is rotated in the one direction; and
a third gear rotatably installed on the body to mesh with at least a portion of the second gear, which rotates the rotating bracket in the one direction when the second gear is rotated in the other direction.

4. The cassette connecting device of claim 3, wherein the power transmission unit further includes a return spring elastically connected between a fixed bracket of the body and the rotating bracket to return the third gear to an initial position thereof when the push of the handle frame against the first gear is released.

5. The cassette connecting device of claim 1, wherein the body includes:
a support frame;
a rotation shaft provided at a lower portion of the support frame, to which the handle frame is rotatably connected;
a moving shaft provided at an upper portion of the support frame to be movable in a front-rear direction of the support frame; and
a support plate having a lower portion rotatably connected to the rotation shaft and an upper portion rotatably connected to the moving shaft.

6. The cassette connecting device of claim 5, wherein the body further includes:
a guide frame that hinge-connects between both sides of the support plate and both sides of the handle frame; and
a guide pin that is coupled to both sides of the support plate, and
wherein the guide frame includes:
a guide rod portion having one end portion hinge-connected to an upper portion of the handle frame; and
a guide slit portion formed to extend at the other end portion of the guide rod portion so that the guide pin is guided in a length direction of the guide rod portion.

7. The cassette connecting device of claim 5, wherein the support frame includes:
a support frame portion; and
a support hole portion formed to extend in the front-rear direction in a sidewall of the support frame portion to provide a movement path of the moving shaft.

8. A cassette connecting device for an automated teller machine, which is to be installed in a replenishment access section and to which a replenishment cassette is to be connected, the cassette connecting device comprising:
a body installed in the replenishment access section and providing a receiving space into which the replenishment cassette is to be inserted; and
a connection connector movably arranged on the body to be electrically connected to a cassette connector of the replenishment cassette,
wherein the connection connector is arranged at a preset first point of the body before the replenishment cassette is inserted into the receiving space, and is arranged at a second point corresponding to the cassette connector when the replenishment cassette is inserted into the receiving space.

9. The cassette connecting device of claim 8, further comprising:
a handle frame rotatably connected to the body to open and close the receiving space; and
a power transmission unit configured to move the connection connector in the body in conjunction with the rotation of the handle frame.
